(19) United States
(12) Patent Application Publication
(10) Pub. No.: US 2010/0147127 A1
(43) Pub. Date: Jun. 17, 2010

(54) COMBINATION TABLE-MITER SAW WITH ADJUSTABLE LIGHT

(75) Inventor: John C. Janson, Plymouth, MI (US)

Correspondence Address: FOLEY & LARDNER LLP, 777 EAST WISCONSIN AVENUE, MILWAUKEE, WI, 53202-5306, US

(73) Assignee: CREDO TECHNOLOGY CORPORATION

(21) Appl. No.: 12/334,239

(22) Filed: Dec. 12, 2008

(51) Int. Cl. B27B 27/06; F21L 4/00

(52) U.S. Cl. 83/471.3; 362/191

(57) ABSTRACT

A combination table-miter saw includes a base, a support arm rotatable relative to the base and configured to support a cutting tool and a platform coupled to the support arm and moveable relative to the base between a first position, wherein the combination table-miter saw functions as a miter saw, and a second position, wherein the combination table-miter saw functions a table saw. The combination table-miter saw further includes an illumination device supported at an underside of the platform for illuminating the base when the platform is in the first position. The illumination device includes a housing movable relative to the platform in a direction substantially parallel with a cutting line defined by the cutting tool and at least one lamp assembly supported by the housing. The at least one lamp assembly has a light source and a reflector that is selectively adjustable relative to the housing for directing a beam of light emitting from the light source.

### BACKGROUND

The present disclosure relates generally to a combination table-miter saw. More specifically, the present disclosure relates to a combination table-miter saw incorporating an adjustable light system.

A combination table-miter saw, like most power tools used for cutting a workpiece, requires precise control and/or alignment of a cutting tool in order to achieve a desired cut. In order for a user to have precise control and/or alignment of the cutting tool and the workpiece, the user of the tool must have good visibility of the workpiece at the point of the cut. Such visibility can be reduced by a insufficient lighting provided around the power tool. However, even if there is sufficient lighting around the power tool, the power tool itself and/or the user and/or the workpiece may interfere with (e.g., block, etc.) ambient light reaching the workpiece at the point of the cut. Such an occurrence may create a shadow on the workpiece making it difficult to properly align the cutting tool relative to the workpiece. This may be particularly true for combination table-miter saws when used in miter saw mode of operation due to the position of the table saw platform above the workpiece and cutting tool.

There is thus a need for a combination table-miter saw that provides increased visibility at the point of a cut made in a workpiece during a miter saw mode of operation. There is also a need for an improved adjustable light system that can be used with any of a variety of power tools for illuminating a workpiece.

It would be desirable to provide a combination table-miter saw and/or a light system that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY

An exemplary embodiment relates to a combination table-miter saw including a base, a support arm rotatable relative to the base and configured to support a cutting tool and a platform coupled to the support arm and moveable relative to the base between a first position, wherein the combination table-miter saw functions as a miter saw, and a second position, wherein the combination table-miter saw functions a table saw. The combination table-miter saw further includes an illumination device supported at an underside of the platform for illuminating the base when the platform is in the first position. The illumination device includes a housing mounted to, but movable relative to the platform in a direction substantially parallel with a cutting line defined by the cutting tool and at least one lamp assembly supported by the housing. The at least one lamp assembly has a light source and a reflector that is selectively adjustable relative to the housing for directing a beam of light emitting from the light source.

Another exemplary embodiment relates to a power tool including a base configured to support a workpiece, a support arm coupled to the base and being configured to support a cutting tool along with a platform coupled to the support arm. The power tool also includes an illumination device supported at an underside of the platform for illuminating the base. The illumination device includes a housing movable relative to the platform in a direction substantially parallel with a cutting line defined by the cutting tool. The illumination device also includes a first lamp assembly supported by the housing and a second lamp assembly supported by the housing. The first lamp assembly and the second lamp assembly each have a light source and a reflector that is selectively adjustable relative to the housing for directing a beam of light emitting from the light source. Adjustment of the reflector of the first lamp assembly is independent from adjustment of the reflector of the second lamp assembly.

Another exemplary embodiment relates to a light system for a power tool having a cutting tool defining a cutting line. The light system includes a housing configured to be mounted to the power tool and movable relative to the power tool in a direction that is substantially parallel with a cutting line defined by the cutting tool. The light system further includes a first lamp assembly supported by the housing and a second lamp assembly supported by the housing. The first lamp assembly and the second lamp assembly each have a light source and a reflector that is selectively adjustable relative to the housing for directing a beam of light emitting from the light source. Adjustment of the reflector of the first lamp assembly is independent from adjustment of the reflector of the second lamp assembly.

### BRIEF DESCRIPTION OF THE DRAWINGS

FIG. 1 is a perspective view of a combination table-miter saw according to an exemplary embodiment, shown in a miter saw position.

FIG. 2 is a perspective view of the combination table-miter saw of FIG. 1, shown in a table saw position.

FIG. 3 is a perspective view of a light system of the combination table-miter saw of FIG. 1 according to an exemplary embodiment.

FIG. 4 is an exploded perspective view of the light system of FIG. 3.

FIG. 5 is an exploded perspective view of a lamp assembly of the light system of FIG. 3 according to an exemplary embodiment.

FIG. 6 is another perspective view of the combination table-miter saw of FIG. 1, shown in the miter saw position.

### DETAILED DESCRIPTION

Referring generally to the FIGURES, a combination table-miter saw 10 and components thereof are shown according to an exemplary embodiment. The combination table-miter saw 10 is selectively adjustable by a user between a first mode or miter saw position (i.e., for use in a miter saw or “chop saw” mode of operation) and a second mode or table saw position (i.e., for use in a table saw mode of operation). In the miter saw position or mode, the combination table-miter saw 10 is configured to provide a user with the functionality of a typical miter saw. Likewise, in the table saw position or mode, the combination table-miter saw 10 is configured to provide a user with the functionality of a typical table saw.

The combination table-miter saw 10 includes an illumination device or light system 100 that is configured to provide increased visibility at or near the point of cut made in a workpiece when the combination table-miter saw 10 is being operated in the miter saw position or mode. Inclusion of the light system 100 may at least partially negate any shadows that may be cast upon a workpiece due to an overhead or ambient light being at least partially blocked by a portion of the combination table-miter saw 10 that provides for the table saw functionality (e.g., a platform, table, etc.). According to an exemplary embodiment, the light system 100 is adjustable in a manner that allows a user to selectively control the positioning and/or direction of the light emanating from the light system 100. The light system 100 may be adjustable by allowing the positioning of the light system 100 to be moved and/or by allowing the light emitted from the light system 100 to be selectively directed or otherwise controlled.

It should be understood that, although the light system 100 is described herein with reference to the exemplary embodiment of a combination table-miter saw 10, the light systems 100 may be applied to, and/or find utility in, other types of power tools as well (e.g., conventional miter saws, radial saws, tile saws, chop saws, etc.).

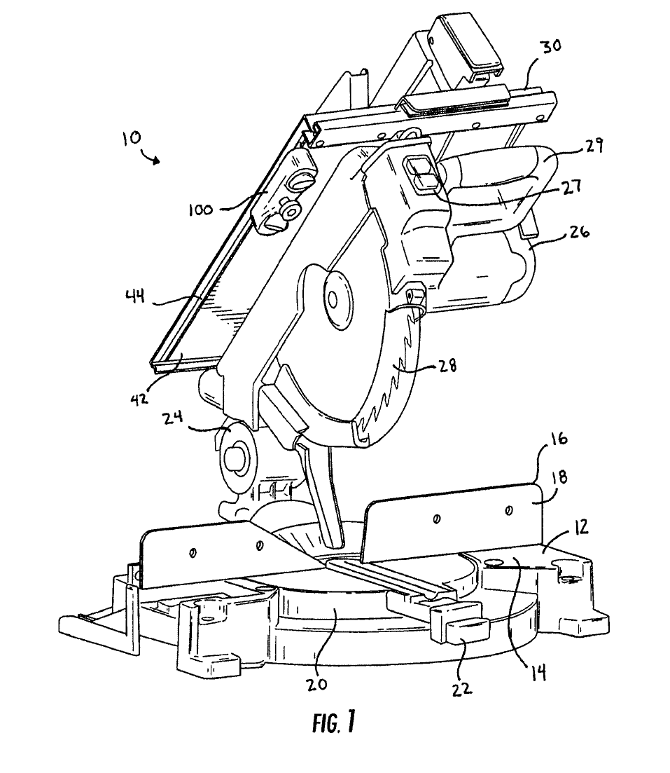

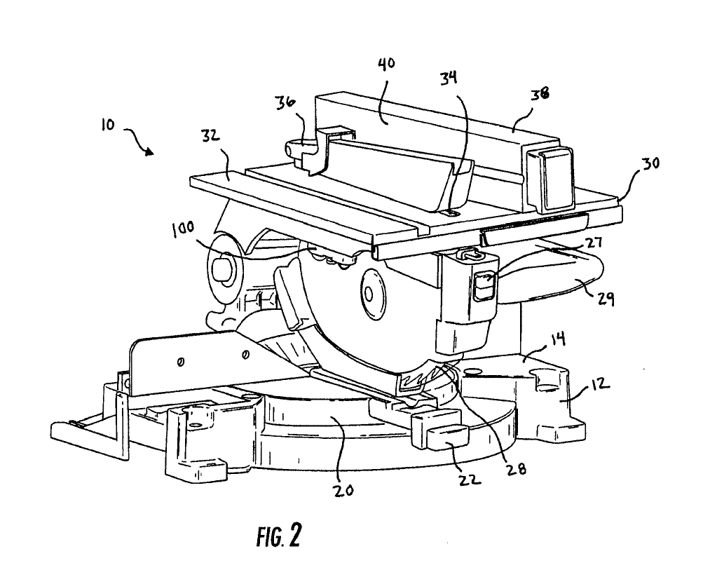

Referring to FIGS. 1 and 2, the combination table-miter saw 10 is shown according to an exemplary embodiment. The combination table-miter saw 10 includes a base 12 having a first workpiece support surface 14. A fence 16 is typically supported on the base 12 (e.g., by being adjustably mounted thereto, etc.). The fence 16 has a second workpiece support surface 18. According to an exemplary embodiment, the first workpiece support surface 14 and the second workpiece support surface 18 are both generally planar surfaces that are orientated substantially perpendicular to each other. According to the embodiment illustrated, the first workpiece support surface 14 extends in a substantially horizontal plane, while the second workpiece support surface 18 extends in a substantially vertical plane. When the combination table-miter saw 100 is in the miter saw position or mode (shown in FIG. 1), the workpiece is supported on the first workpiece support surface 14 and positioned against the second workpiece support surface 18.

The combination table-miter saw 10 also includes a table 20 that is rotatably supported at the base 12 and an adjustment device 22 (e.g., handle, lever, etc.) for allowing the user to selectively adjust the position of the table 20 relative to the base 12. Supported at a rear portion of the table (e.g., a side opposite the adjustment device 20, etc.) is an arm 24. The arm 24 holds a motor housing or saw unit 26 having a circular cutting tool, shown as a toothed blade 28.

The table 20 is rotatably adjustable relative to the second workpiece support surface 18 so that the table 20 (and the saw unit 26 mounted relative thereto) can be angularly positioned to set a desired miter cut angle. The arm 24 is movably (e.g., pivotally, etc.) mounted relative to the first workpiece support surface 14 to permit the saw unit 26 to be selectively moved upwards and downwards to cut a workpiece on the first workpiece support surface 14. According to an exemplary embodiment, the arm 24 is also mounted to permit a lateral angular adjustment to tilt the blade 28.

According to an exemplary embodiment, the saw unit 26 is made of an electrically insulating material, such as hard plastic. An electric motor is enclosed within the saw unit 26. The motor receives electrical power from a power source (e.g., through an electrical cord and/or via an energy storage device such as a battery, etc.). The electric motor is turned on and off by a power on/off switch 27 supported at a front portion of the saw unit 26. Also supported at the front portion of the saw unit 26 is a handle 29 that can be grasped by a user to selectively move the saw unit 26 (and thus the blade 28) relative to the base 12.

In addition to facilitating the cutting of a workpiece when the combination table-miter saw 10 is in the miter saw position or mode, rotational movement of the arm 24 relative to the base 12 also allows the combination table-miter saw 10 to be selectively moved from the miter saw position to the table saw position (shown in FIG. 2). To achieve the table saw position, the saw unit 26 is lowered relative to the base 12 and is locked or otherwise secured in such a position or mode.

To facilitate its functionality as a table saw, the combination table-miter saw 10 further includes table or platform 30 that is supported at a top portion of the saw unit 26 as seen in FIG. 2. The platform 30 extends outward from the saw unit 26 and has a third workpiece support surface 32 that defines an aperture or slot 34 that allows the blade 28 to pass through the third workpiece support surface 32 and engage the workpiece. The slot 34 allows the same cutting tool that is used in the miter saw mode to be used in the table saw mode. The combination table-miter saw 10 also includes a cover or guard 36 that at least partially conceals the portion of blade 28 extending through the slot 34. The guard 36 is configured to moved when engaged by a workpiece intended to be cut in the table saw mode of operation so that the blade 28 can engage the workpiece.

A second fence 38 is supported on the platform 30 (e.g., by being adjustably mounted thereto, etc.). The second fence 38 has a fourth workpiece support surface 40 that is configured to be substantially parallel with a cutting edge of the blade 28. According to an exemplary embodiment, the third workpiece support surface 32 and the fourth workpiece support surface 40 are both generally planar surfaces that are orientated substantially perpendicular to each other. According to the embodiment illustrated, the third workpiece support surface 32 extends in a substantially horizontal plane when the combination table-miter saw 10 is in the table saw position, while the fourth workpiece support surface 40 extends in a substantially vertical plane.

According to an exemplary embodiment, the second fence 38 is laterally slidably adjustable relative to the third workpiece support surface 32 and the cutting blade 28 so that the second fence 38 can be positioned to set a desired width for the cut for the workpiece. In the table saw mode, the workpiece slides along the third workpiece support surface 32 towards the blade 28 while being pressed against the fourth workpiece support surface 40. As the workpiece approaches the blade 28, the workpiece engages the guard 36 and lifts it upward relative to the third workpiece support surface 32 to permit the blade 28 to engage the workpiece and make the desired cut. According to an exemplary embodiment, the height that the blade 28 extends through the slot 34 is adjustable to accommodate workpieces of varying thickness and/or to control the depth of the cut in the workpiece.

According to an exemplary embodiment, the combination table-miter saw 10 provides for improved visibility of a workpiece when the combination table-miter saw 10 is being used in the miter saw mode. The improved visibility may be provided at the point of a cut being made by the blade 28 and/or an area around the point of the cut. To facilitate the improved visibility, the combination table-miter saw 10 includes the light system 100. The light system 100 is preferably supported at a bottom surface 42 of the platform 30 and includes one or more light sources configured to cast light down onto the first workpiece support surface 14. Such placement of the light system 100 improves the otherwise poor lighting condition caused by the shadow created when the platform 30 substantially blocks any meaningful overhead or ambient light from reaching the first workpiece support surface 14.

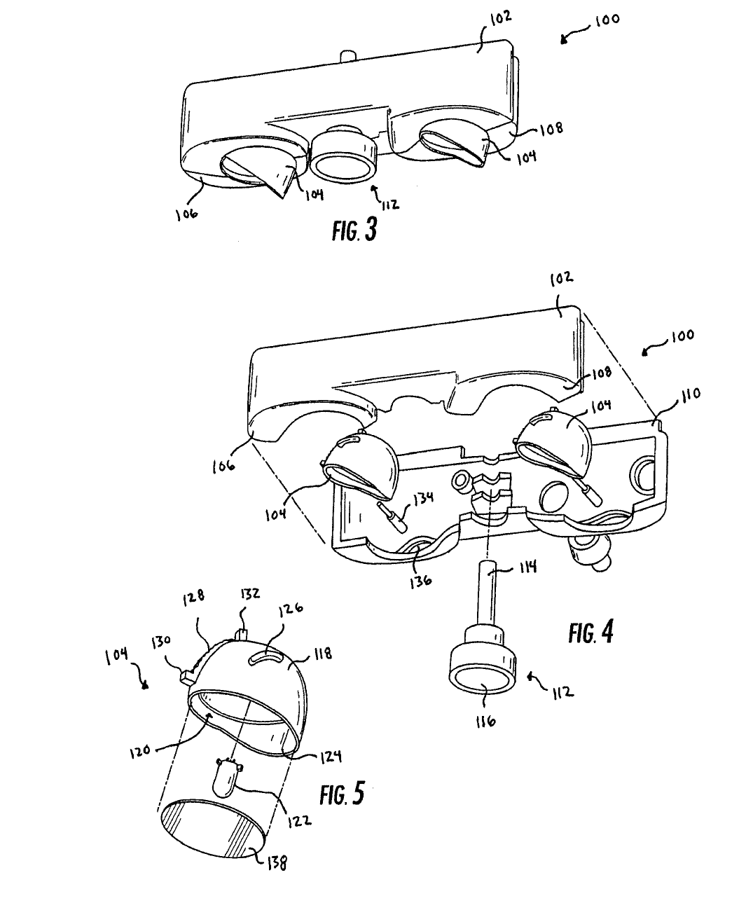

Referring to FIGS. 3 through 5, the light system 100 is shown according to an exemplary embodiment. The light system 100 includes a housing 102 configured to support one or more lamp assemblies 104. According to an exemplary embodiment, the housing 102 is made of an electrically insulating material, such as a hard plastic. The housing 102 is generally elongated in shape, and may define a first light emitting region or area 106 and a second light emitting region or area 108. The first area 106 and the second area 108 each define an aperture (e.g., opening, passage, hole, etc.) configured to receive a lamp assembly 104. The housing 102 may be made be formed as two or more molded pieces which are joined together to form the housing 102 such as by using one or more fasteners, an adhesive, welding or a combination thereof.

According to an exemplary embodiment, the position of the housing 102 is configured to be supported on the bottom surface 42 of the platform 30 at a side of the blade 28 opposite the electric motor (e.g., at a left side of the blade 28 when viewed from the front of the combination table-miter saw 10, etc.). Preferably, the position of the housing 102 is selectively adjustable relative to the platform 30 in a direction substantially parallel to the cutting line of the blade 28. According to an exemplary embodiment, the housing 102 is configured to slide relative to platform 30 to a desired position while remaining secured to the platform 30.

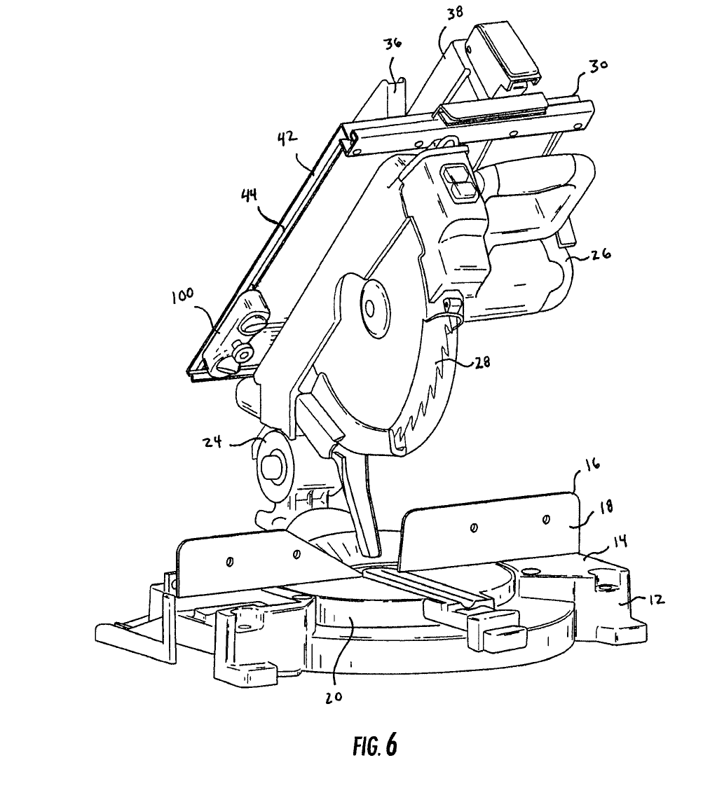

To facilitate the movement of the housing 102 relative to the platform 30, the bottom surface 42 of the platform 30 includes a first attachment structure, shown as a slot or a channel 44 in FIG. 1, while the housing 102 includes a corresponding second attachment structure, shown as a projection 110 in FIG. 4. The channel 44 is shown as extending in a direction that is substantially parallel with and laterally spaced from the cutting line of the blade 28 and spans across substantially the entire depth of the platform 30. The projection 110 is configured to slidably engage and follow the channel 44 to provide for the guided movement of the housing 102 relative to the platform 30. According to the various alternative embodiments, the bottom surface 42 may include the projection, while the housing 102 includes a substantially complementary channel. Allowing the light system 100 to be selectively moved along the bottom surface 42 of the platform 30 may advantageously allow the user to optimize the positioning of the light source depending on the type of cut being done and/or the size of the workpiece. For example, in certain application it may be more desirable to have the light system 100 positioned towards the front of the platform 30 (as shown in FIG. 1), while in other applications it may be more desirable to have the light system 100 positioned towards the back of the platform 30 (as shown in FIG. 6).

To retain or otherwise secure the housing 102 along the channel 44, the light system 100 includes a locking device 112. The locking device 112 includes a first portion or end 114 that is configured to be received by an aperture in the housing 102 and engage the platform 30 and a second portion having a user interface, shown as a knob 116. In operation, a user manipulates the knob 116 to release the first end 114 from the platform 30. Once released, the user can freely reposition the housing 102 along the channel 44. When the desired position is achieved, the first end 114 reengages the platform 30 for securing the housing 102 in such a position.

According to an exemplary embodiment, the locking device 112 may be a locking screw, wherein the first end 114 is threaded and configured to engage a corresponding thread provided on the housing 102. In such an embodiment, a user would rotate the knob 116 in a first direction to release the locking device 112 from the platform 30 and would rotate the knob 116 in an opposite second direction to engage the bottom surface 42 of the platform 30. Such a configuration may advantageously allow the housing 102 to be secured in a relatively infinite number of positions along the channel 44. According to another exemplary embodiment, the locking device 112 may be a locking pin that is biased towards a locked position. For example, a biasing element (e.g., a spring, etc.) may act on the first end 114 to urge the first end 114 into engagement with the bottom surface 42 of the platform 30. In such an embodiment, a user would pull downward on the knob 116 away from the platform 30 to overcome the biasing force. Once the biasing force is overcome, the user can then selectively adjust the position of the housing 102. In such a configuration, the first end 114 may be configured to engage any portion of the platform 30 to retain the housing 102, or alternatively, one or more recesses or apertures configured to receive the first end 114 may be provided along the channel 44 to provide for predetermined locking areas for the housing 102.

According to the embodiment illustrated, the locking device 112 is centrally supported on the housing 102 between the first area 106 and the second area 108. According to an exemplary embodiment, the area on the housing 102 that receives the locking device 112 is slightly recessed relative to the first area 106 and the second area 108. Such a configuration positions the knob 116 lower relative to the housing 102 so that the knob 116 does not block or otherwise interfere with the light emanating from the lamp assemblies 104.

To provide further control over the workpiece illumination when the combination table-miter saw 10 is operating in the miter saw mode, each of the lamp assemblies 104 is adjustable relative to the housing 102. According to an exemplary embodiment, the lamp assemblies 104 are configured to independently swivel or rotate within the apertures defined by the housing 102 to further control the direction of light. According to the embodiment illustrated, the movement of the lamp assemblies 104 relative to the housing 102 are independent of each other. In other words, the first light assembly can be selectively rotated and set at a first position, and the second light assembly can be selectively rotated and set at a second position. According to the various alternative embodiments, the movement of the lamp assemblies 104 relative to the housing 102 may be synchronized or otherwise linked.

According to an exemplary embodiment, the lamp assembly 104 includes a lamp support member (e.g., lamp casing, pocket, receptacle, etc.), shown as a bezel 118, that is substantially semi-spherical in shape and has an open front portion that provides access to a cavity or recess 120. The recess 120 is configured to receive one or more lamps 122. According to an exemplary embodiment, the lamp 122 is a high-output light emitting diode (LED) having a connector configured to be received by the bezel 118. The LEDs may be implemented using commercially available high-output LEDs.

Outwardly extending from the bezel 118 is a light guide or reflector 124 which extends beyond the edge of the bezel 118. The reflector 124 is configured to further control the direction of the light emitted from the lamp assembly 104. According to the embodiment illustrated, the reflector 124 may be integrally formed with the bezel 118 to provide a unitary one-piece member, or alternatively, may be provided as a separate member that is substantially mounted relative to the bezel 118. According to an exemplary embodiment, the reflector 124 directs the light downward and towards the back of the combination table-miter saw 10. To facilitate this directional control of the light, the reflector 124 is provided at only a front portion the bezel 118, but alternatively, may be provided around the entire periphery (e.g., continuously, intermittently, etc.).

To facilitate the selective control of the lamp assembly 104 relative to the housing 102, the lamp assembly 104 further includes one or more guides, shown as a projection 126, a latching structure, shown as a toothed sector 128, and one or more stop members, shown as a first post 130 and a second post 132. The projection 126 is configured to engage a corresponding recess or slot provided on an inner surface of the housing 102 for defining the path that the lamp assembly 104 follows as it is selectively rotated relative to the housing 102. According to the embodiment illustrated, the projection 126 is provided along a lateral side of the bezel 118 and is shaped as a substantially continuous curve which extends downward as the projection 126 moves towards the back of the combination table-miter saw 10. According to an exemplary embodiment, the projection 126 is provided on both lateral sides of the bezel 118. According to the various alternative embodiments, the projection 126 may be provided at any of a number of locations along the bezel 118 and may be in the form of any of a number of shapes (e.g., linear, curvilinear, or combinations thereof, etc.).

The toothed sector 128 is configured to retain the bezel 118 in the position selectively set by the user. The toothed sector 128 is shown as extending outwardly from the bezel 118 at a relatively central location on the bezel 118. According to an exemplary embodiment, the toothed sector 128 extends in a direction that is substantially parallel with the cutting line of the blade 28. According to the embodiment illustrated, the toothed sector 128 extends in the direction of the cutting line approximately one half of the outer circumference of the bezel 118 or less, and is provided on a side of the bezel opposite the reflector 124. Such a configuration permits the lamp assembly 104 to direct the light downward and towards the back of the combination table-miter saw 10.

The toothed sector 128 includes a plurality a projections or teeth that are configured to engage a corresponding structure provided on an inside surface of the housing 102. Engagement between the two corresponding structures locks the lamp assembly 104 at the desired angle or position relative to the housing 102 until selectively reconfigured by the user. To limit the rotation of the lamp assembly 104 relative to the housing 102, the first post 130 and the second post 132 are provided. According to the embodiment illustrated, the first post 130 is provided at a first end of the toothed sector 128 while the second post 130 is provided at an opposite second end of the toothed section 128. The first post 130 and the second post 132 are configured to engage a corresponding structure on an inner surface of the housing 102 to function as a stop. While the first post 130 and the second post 132 are shown as substantially rectangular members, the first post 130 and the second position 132 may be provided in any of a number of suitable shapes.

To simplify the adjustment of the lamp assemblies 104 relative to the housing 102, each lamp assembly 104 is shown as further including a user interface or control lever 134 (shown in FIG. 4). The control lever 134 has a first end that is mounted to and fixed relative to the bezel 118 and a free second end configured to be grasped by a user. Manipulation of the free second end allows the user to rotate the lamp assembly 104 to control the angle at which light is emitted from the light system 100. The free second end is configured to pass through an opening 136 defined by the housing 102 to provide convenient access for the user. Alternatively, a user may simply press on the bezel 118 to adjust its position relative to the housing 102.

The user may selectively reconfigure the orientation of the lamp assemblies 104 until a desired lighting pattern is achieved. For example, the user may angle the lamp assemblies 104 so that the beams of light emitted by the lamp assemblies form an overlap or intersecting area at or near the point of a cut when the combination table-miter saw 10 is operating in the miter saw mode. Alternatively, the lamp assemblies 104 may be positioned so that the beams of light emitted by the lamp assemblies 104 are spaced apart from each other (e.g., one emitting light on a front portion of the first workpiece support surface 14 and another emitting light on a rear portion of the first workpiece support surface 14).

The lamp assembly 104 also includes a lens 138 supported at the open front portion of the bezel 118. The lens 138 is configured to be used with the lamp 122 and may focus and/or diffuse light emitted by the lamp 122. According to an exemplary embodiment, the lens 138 is coupled to the bezel 118 (e.g., by press-fit, interference fit, a fastener, etc.).

It should be understood that, although two lamp assemblies 104 are illustrated in the exemplary embodiment shown in the FIGURES, more than two lamp assemblies may be incorporated into the housing 102 to illuminate a workpiece and/or an area around the workpiece. Further, while the lamp assemblies 104 are described as utilizing an LED as a light source, the lamp assemblies 104 may be provided with an incandescent bulb or other type of light source.

The present invention provides a light system that allows for increased visibility of a workpiece being cut by a combination table-miter saw in a miter saw mode of operation. Though the light system is described in detail herein with respect to a combination table-miter saw, it should be noted that the present invention is not limited in application to any particular power tool. The features of the present invention may be used with other types of power tools.

Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, protocols, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the scope of the present inventions as expressed in the appended claims.

What is claimed is:

1. A combination table-miter saw comprising:
a base;
a support arm rotatably coupled to the base and configured to support a cutting tool;
a platform coupled to the support arm and moveable relative to the base between a first position, wherein the combination table-miter saw functions as a miter saw, and a second position, wherein the combination table-miter saw functions as a table saw; and
an illumination device supported at an underside of the platform for illuminating the base when the platform is in the first position, the illumination device comprising:
a housing movable relative to the platform in a direction substantially parallel with a cutting line defined by the cutting tool; and
at least one lamp assembly supported by the housing, the at least one lamp assembly having a light source that is selectively adjustable relative to the housing for directing a beam of light emitting from the light source.

2. The combination table-miter saw of claim 1, wherein the housing includes at least one of a channel and a projection for engaging a corresponding structure provided on the platform for guiding the movement of the housing relative to the platform.

3. The combination table-miter saw of claim 2, wherein the housing includes a projection and the platform defines a channel configured to receive the projection, the channel extending substantially the entire depth of the platform.

4. The combination table-miter saw of claim 3, wherein the illumination device further comprises a locking device configured to engage the platform for selectively securing the housing in a desired position along the channel.

5. The combination table-miter saw of claim 1, wherein the at least one lamp assembly further comprises a reflector and a lamp casing configured to receive the light source and support the reflector.

6. The combination table-miter saw of claim 5, wherein the lamp casing is a semi-spherical member having an opening for receiving the light source, the reflector being supported at the opening.

7. The combination table-miter saw of claim 6, wherein the reflector is only provided at a front portion of the lamp casing.

8. The combination table-miter saw of claim 5, wherein the lamp casing is selectively movable relative to the housing and includes a guide structure for defining the movement of the lamp casing relative to the housing.

9. The combination table-miter saw of claim 8, wherein the guide structure is a curved projection extending outward from an outer surface of the lamp casing.

10. The combination table-miter saw of claim 8, wherein the lamp casing includes a latching device for selectively securing the lamp casing in a desired position relative to the housing.

11. The combination table-miter saw of claim 10, wherein the latching device is a toothed sector extending in a central region of the lamp casing.

12. The combination table-miter saw of claim 11, wherein the toothed sector extends only partially across the periphery of the lamp casing.

13. The combination table-miter saw of claim 12, wherein the toothed sector extends no more than half way across the periphery of the lamp casing.

14. The combination table-miter saw of claim 13, wherein the toothed sector is provided on a side of the lamp casing substantially opposite the reflector.

15. The combination table-miter saw of claim 11, wherein the lamp casing further includes a first stop member provided at a first end of the toothed sector and a second stop member provided at a second end of the tootled sector, the first stop member and the second stop member limiting the movement of the lamp casing relative to the housing.

16. The combination table-miter saw of claim 1, wherein the at least one lamp assembly comprises a first lamp assembly and a second lamp assembly, the housing defining a first area for supporting the first lamp assembly and a second area for supporting the second lamp assembly, and the first lamp assembly and the second lamp assembly being selectively adjustable relative to the housing and independent of each other.

17. The combination table-miter saw of claim 16, wherein the illumination device further comprises a latching device for releasably retaining the housing relative to the platform, the latching device having a user interface that is supported within a recess provided between the first area and the second area.

18. The combination table-miter saw of claim 1, wherein the light source comprise a light emitting diode.

19. A power tool comprising:
a base configured to support a workpiece;
a support arm coupled to the base and configured to support a cutting tool;
a platform coupled to the support arm; and
an illumination device supported at an underside of the platform for illuminating the base, the illumination device comprising:
a housing movable relative to the platform in a direction substantially parallel with a cutting line defined by the cutting tool; and
a first lamp assembly supported by the housing and a second lamp assembly supported by the housing, the first lamp assembly and the second lamp assembly each having a light source and a reflector that is selectively adjustable relative to the housing for directing a beam of light emitting from the light source,
wherein adjustment of the reflector of the first lamp assembly is independent from adjustment of the reflector of the second lamp assembly.

20. A light system for a power tool having a cutting tool defining a cutting line, the light system comprising:
a housing configured to be mounted to the power tool and movable relative to the power tool in a direction that is substantially parallel with a cutting line defined by the cutting tool; and
a first lamp assembly supported by the housing and a second lamp assembly supported by the housing, the first lamp assembly and the second lamp assembly each having a light source and a reflector that is selectively adjustable relative to the housing for directing a beam of light emitting from the light source,
wherein adjustment of the reflector of the first lamp assembly is independent from adjustment of the reflector of the second lamp assembly.
